(19) United States
(12) Patent Application Publication
(10) Pub. No.: US 2026/0264715 A1
(43) Pub. Date: Sep. 10, 2026

(54) MOVING BODY, METHOD FOR CONTROLLING MOVING BODY, AND RECORDING MEDIUM

(71) Applicant: NEC Corporation, Tokyo (JP)

(72) Inventors: Masaaki TAKEUCHI, Tokyo (JP); Masanori KUKI, Tokyo (JP); Shintaro CHIKU, Tokyo (JP); Sawaka SEK!, Tokyo (JP); Yoji OHNISHI, Tokyo (JP)

(73) Assignee: NEC Corporation, Tokyo (JP)

(21) Appl. No.: 19/154,811

(22) PCT Filed: Feb. 20, 2023
(86) PCT No.: PCT/JP2023/005974

§ 371 Date: Aug. 8, 2025

(51) Int. Cl. B60W 60/00; B60W 50/14

(52) U.S. Cl. CPC B60W 60/001; B60W 50/14; B60W 2050/143; B60W 2050/146; B60W 2420/403; B60W 2556/45

(57) ABSTRACT

This moving body includes a camera, a movement unit moving autonomously on the basis of information set in advance, a transmission unit that, during movement by the movement unit, transmits images taken by the camera to a predetermined control center, a determination unit that determines whether or not an event appearing in an image from the camera conforms to a predetermined autonomous driving stop condition, and a control unit for, in the case where an event conforming to the autonomous driving stop condition has occurred, shifting to an operating mode for staying at the location where the event occurred and continuing to take images and transmit the images to the control center.

### TECHNICAL FIELD

The present disclosure relates to a moving body, a method for controlling a moving body, and a recording medium.

### BACKGROUND ART

PTL 1 discloses a drone security system capable of taking measures such as rushing a security guard to a site where an abnormality such as an intrusion act or a fire is caused. According to PTL 1, the drone security system includes a drone including a camera, a cloud server, and a security guard terminal. The drone transmits imaging data to the cloud server, the imaging data being captured by the camera during flight in a predetermined course. PTL 1 describes the cloud server that analyzes the imaging data received from the drone by using a video analysis means, and notifies the security guard terminal of any of detections having been performed, such as intrusion act detection into a predetermined area, fire detection, smoke detection, violent act detection, falling object detection, article interception act detection, illegal dumping act detection, illegal waste detection, illegal parking act detection, illegal parking detection, fallen person detection, and rescue requirement gesture detection.

### CITATION LIST

### Patent Literature

PTL 1: JP 2021-180374 A

### SUMMARY OF INVENTION

### Technical Problem

PTL 1 exemplifies a monitoring system that has a problem of failing to address a situation difficult to be determined by the imaging data because the video analysis means of the cloud server is configured to analyze the imaging data received from the drone. For the problem, dispatching personnel is conceivable as a response to the notification even when such an image difficult to be determined is obtained. However, this response causes a problem of requiring many personnel resources for a widespread event to be detected. Detected events may include a conceivable event in which waiting for dispatch of personnel causes missing the right timing.

It is an object of the present disclosure to provide a moving body, a method for controlling a moving body, and a recording medium, which are each capable of quickly and accurately grasping contents of an occurrence event with less personnel.

### Solution to Problem

According to a first viewpoint, provided is a moving body including a camera, a movement means for autonomous moving based on information set in advance, a transmission means for transmitting an image captured by the camera to a predetermined control center during movement using the movement means, a determination means for determining whether an event appearing in the image captured by the camera conforms to a predetermined autonomous driving stop condition, and a control means for shifting to an operation mode when an event conforming to the autonomous driving stop condition has occurred, the operation mode being for remaining at a location where the event has occurred and continuing to capture an image and transmit the image to the predetermined control center.

According to a second viewpoint, provided is a method for controlling a moving body, the method including: allowing a moving body including a camera, a movement means for autonomous moving based on information set in advance, and a transmission means for transmitting an image captured by the camera to a predetermined control center during movement using the movement means to determine whether an event appearing in the image captured by the camera conforms to a predetermined autonomous driving stop condition; remaining at a location where the event has occurred when the event conforming to the autonomous driving stop condition has occurred; and continuing to capture an image and transmitting the image to the predetermined control center.

According to a third viewpoint, provided is a recording medium recording a program for causing a computer to execute processing, the computer being mounted on a moving body including a camera, a movement means for autonomous moving based on information set in advance, and a transmission means for transmitting an image captured by the camera to a predetermined control center during movement using the movement means, the processing including: determining whether an event appearing in the image captured by the camera conforms to a predetermined autonomous driving stop condition; and remaining at a location where the event has occurred and continuing to capture an image and transmit the image to the predetermined control center when the event conforming to the autonomous driving stop condition has occurred.

### Advantageous Effects of Invention

The present disclosure provides a moving body, a method for switching a driving mode, and a recording medium, which are each capable of quickly and accurately grasping contents of an occurrence event with less personnel.

### BRIEF DESCRIPTION OF DRAWINGS

FIG. 1 is a diagram illustrating a configuration of one example embodiment of the present disclosure.

FIG. 2 is a flowchart illustrating an operation of one example embodiment of the present disclosure.

FIG. 3 is a diagram illustrating a configuration of a first example embodiment of the present disclosure.

FIG. 4 is a block diagram illustrating a configuration of an automatic driving vehicle according to the first example embodiment of the present disclosure.

FIG. 5 is a diagram for illustrating a condition under which the automatic driving vehicle according to the first example embodiment of the present disclosure stops autonomous driving.

FIG. 6 is a flowchart for illustrating an operation of the automatic driving vehicle according to the first example embodiment of the present disclosure.

FIG. 7 is a diagram for illustrating the operation of the automatic driving vehicle according to the first example embodiment of the present disclosure.

FIG. 8 is another diagram for illustrating the operation of the automatic driving vehicle according to the first example embodiment of the present disclosure.

FIG. 9 is yet another diagram for illustrating the operation of the automatic driving vehicle according to the first example embodiment of the present disclosure.

FIG. 10 is a block diagram illustrating a configuration of an automatic driving vehicle according to a second example embodiment of the present disclosure.

FIG. 11 is a block diagram illustrating a configuration of an automatic driving vehicle according to a third example embodiment of the present disclosure.

FIG. 12 is a block diagram illustrating a configuration of an automatic driving vehicle according to a fourth example embodiment of the present disclosure.

FIG. 13 is another diagram for illustrating an operation of a drone according to a fifth example embodiment of the present disclosure.

FIG. 14 is a diagram illustrating a configuration of a computer that can function as a moving body of the present disclosure.

### EXAMPLE EMBODIMENT

An outline of an example embodiment of the present disclosure will be described with reference to the drawings. Reference numerals in the drawings attached to this outline are attached to each element for convenience as an example for assisting understanding, and are not intended to limit the present disclosure to illustrated aspects. Connection lines between blocks in the drawings and the like referred to in the following description include both bidirectional and unidirectional. An unidirectional arrow schematically indicates a flow of a main signal (data), and does not exclude bidirectionality. A program is executed using a computer device, and the computer device includes a processor, a storage device, an input device, a communication interface, and a display device as necessary, for example. The computer device is configured to be able to communicate with a device (including a computer) inside or outside the device using a communication interface regardless of wired or wireless. Although a port or an interface exits at a connection point of input or output of each block in the drawing, they are not illustrated.

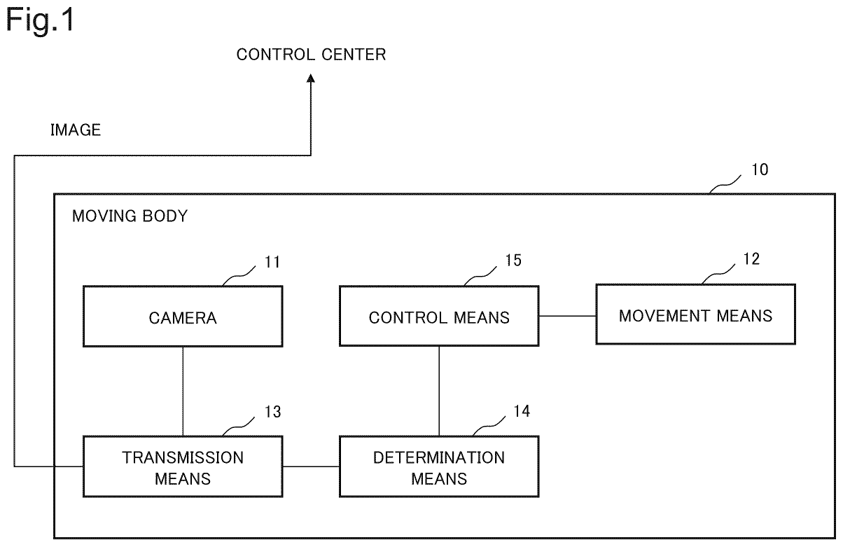

The present disclosure enables implementing a moving body 10 in its example embodiment, the moving body 10 including a camera 11, a movement means 12, a transmission means 13, a determination means 14, and a control means 15 as illustrated in FIG. 1.

More specifically, the movement means 12 includes various propulsion devices functioning as movement means for autonomously moving based on information set in advance, and a control device that controls the propulsion devices. Although conceivable examples of the information set in advance include various settings such as causing the moving body 10 to move around in a designated route and to move around mainly places with many people and automobiles, the information is not particularly limited.

The transmission means 13 transmits an image captured by the camera 11 to a predetermined control center during movement using the movement means 12. As the camera 11, the movement means 12, and the transmission means 13 described above, those provided in an unmanned aerial vehicle (UAV) called a drone, or in an automatic driving vehicle, can be used.

The determination means 14 determines whether an event shown in an image of the camera 11 conforms to a predetermined autonomous driving stop condition. For example, the determination means 14 determines whether a suspicious object is shown in an image captured by the camera 11, and notifies the control means 15 of a result of the determination.

When an event conforming to the autonomous driving stop condition occurs, the control means 15 shifts to an operation mode of remaining at a place where the event has occurred and continuing to capture an image and transmit the image to the control center. For example, when the determination means 14 has determined that the suspicious object is shown, the control means 15 causes the moving body 10 to shift to the operation mode of remaining at a place where the event has occurred and continuing to capture an image and transmit the image to the control center.

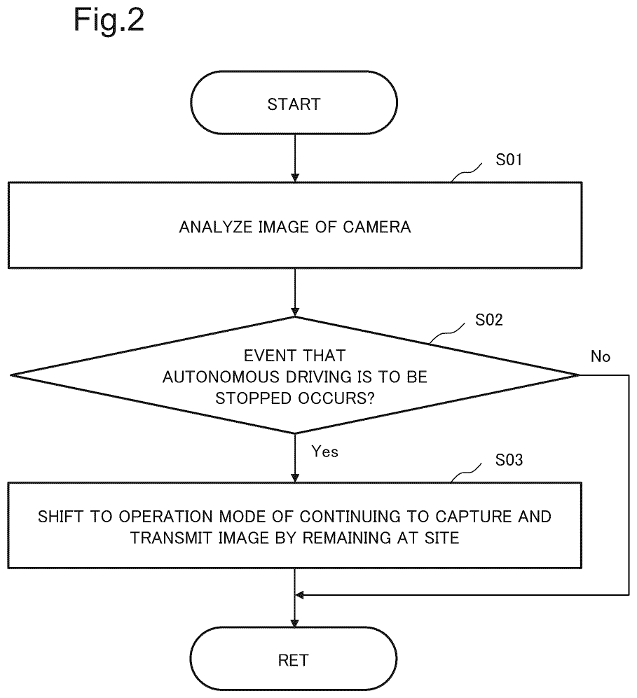

FIG. 2 illustrates a method for controlling a moving body. The moving body 10 configured as described above operates as follows. As illustrated in FIG. 2, the moving body 10 analyzes and image captured by the camera 11 at predetermined time intervals (step S01), and determines whether an event conforming to the predetermined autonomous driving stop condition has occurred (step S02). When it is determined that the event conforming to the predetermined autonomous driving stop condition has not occurred, the moving body 10 continues autonomous driving (No in step S02).

In contrast, when it is determined that the event conforming to the predetermined autonomous driving stop condition has occurred, the moving body 10 shifts to the operation mode of remaining at a place where the event has occurred and continuing to capture an image and transmit the image to the control center (step S03). In this case, the moving body 10 may notify the control center of a type and contents of the event having occurred.

The moving body 10 having shifted to the operation mode remains at the place where the event has occurred, and continues to capture an image and transmit the image to the control center. For example, when the suspicious object described above is found, the moving body 10 approaches the suspicious object, captures an image of the suspicious object with the camera 11, and transmits the image to the control center. A person in charge of the control center checks details by referring to the image transmitted from the moving body 10. Alternatively, the moving body 10 may transmit a picture of the photographed suspicious object to a person other than that in the control center as necessary.

As described above, the present disclosure enables grasping the contents of the event having occurred quickly and accurately with less personnel.

### First Example Embodiment

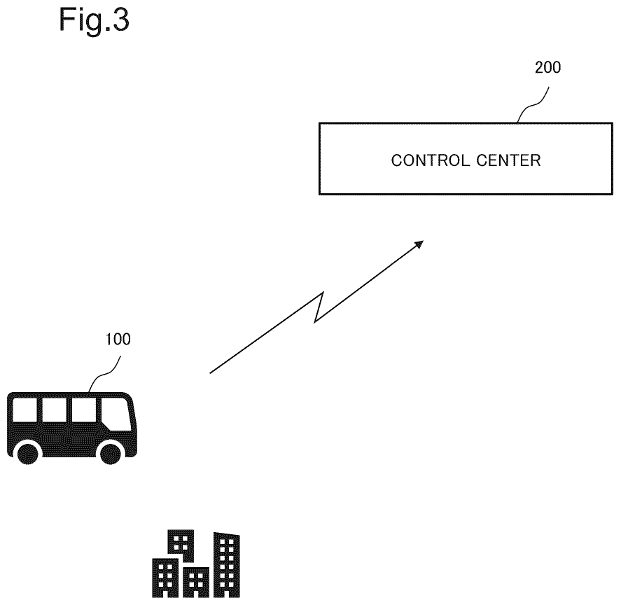

Subsequently, a first example embodiment will be described in detail, in which a function of changing a driving mode in accordance with a situation is added to an automatic driving vehicle that autonomously travels and transmits an image to a control center, with reference to the drawings. FIG. 3 is a diagram illustrating a configuration of the first example embodiment of the present disclosure. Referring to FIG. 3, a configuration including one or more automatic driving vehicles 100 and a control center 200 that receives an image from the automatic driving vehicles 100 and supports a traffic control operation and a monitoring operation is illustrated.

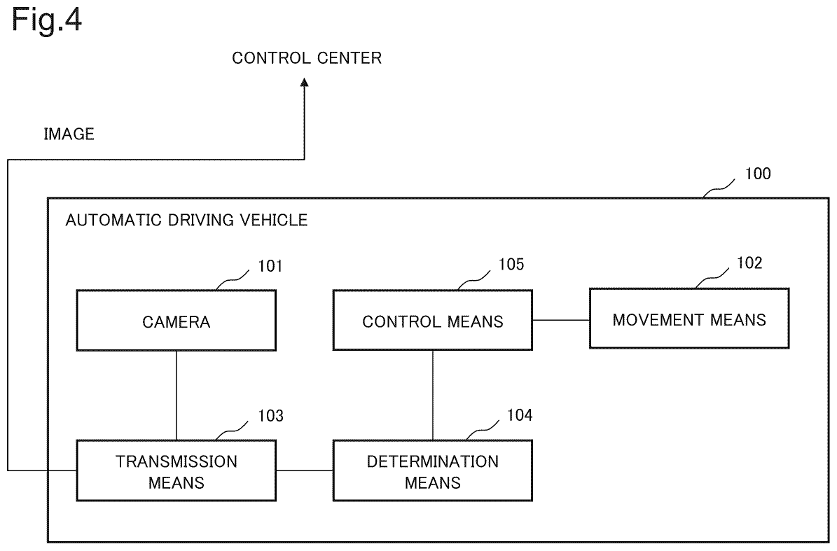

FIG. 4 is a block diagram illustrating a configuration of each automatic driving vehicle 100 according to the first example embodiment of the present disclosure. Referring to FIG. 4, the automatic driving vehicle 100 including a camera 101, a movement means 102, a transmission means 103, a determination means 104, and a control means 105 is illustrated.

The movement means 102 allows the automatic driving vehicle 100 to move autonomously based on information set in advance, and specifically includes a plurality of wheels, a motor that drives the wheels, a control device, and the like.

The transmission means 103 transmits an image captured by the camera 101 to the control center 200 during movement using the movement means 102.

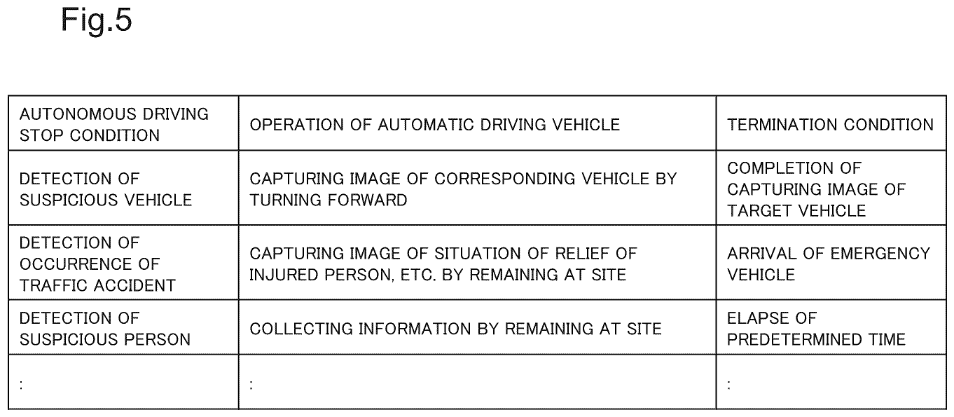

The determination means 104 determines whether an event shown in an image of the camera 101 conforms to a predetermined autonomous driving stop condition. FIG. 5 is a table illustrating a correspondence relationship among conditions (autonomous driving stop conditions) under which the determination means 104 of the automatic driving vehicle 100 stops autonomous driving, an operation performed by the automatic driving vehicle 100 according to an operation mode switched when an event associated with each condition is detected, and a termination condition of the operation mode.

For example, when a suspicious vehicle is detected, the determination means 104 determines that an event conforming to the autonomous driving stop condition has occurred. In this case, the automatic driving vehicle 100 turns to the front of the corresponding vehicle and captures an image. Consequently, an image of the suspicious vehicle is transmitted to the control center 200. The person in charge of the control center 200 checks whether there is a driver with reference to the image received from the automatic driving vehicle 100, and performs recording of a license plate and communication with the relevant authorities if necessary. Similarly, when a traffic accident vehicle is detected, the determination means 104 determines that an event conforming to the autonomous driving stop condition has occurred. In this case, the automatic driving vehicle 100 remains at a site of the traffic accident and captures images of a situation of the accident, a situation of relief of an injured person, and the like. Consequently, the images of the site after the traffic accident are transmitted to the control center 200. The person in charge of the control center 200 makes arrangement for an ambulance and performs communication with contacts the police.

Similarly, when a suspicious person is detected, the determination means 104 determines that an event conforming to the autonomous driving stop condition has occurred. In this case, the automatic driving vehicle 100 remains at a place where the suspicious person is detected and continues to capture an image. Consequently, when the suspicious person has committed some kind of crime, for example, an image of surroundings immediately after the crime can be captured. Additionally, when there is an accomplice who is suspicious or a person who is damaged, the automatic driving vehicle 100 can capture images of an accomplice of the suspicious person or the person who is damaged. These images are transmitted to the control center 200. The person in charge of the control center 200 can perform communication with the police or a security company with reference to the images.

As described above, determining a position where the automatic driving vehicle 100 should move for each autonomous driving stop condition enables transmission of an appropriate image to the control center 200. Alternatively, a position to which the automatic driving vehicle 100 should move may be determined in more detail for each autonomous driving stop condition in a more desirable form. For example, definition of an image of a vehicle, the image being captured from a predetermined distance in front of the vehicle, has an advantage of facilitating not only recognition of a license plate or the like from the captured image but also management.

FIG. 5 shows an example that determines a termination condition of an operation mode (second autonomous driving mode) of continuing to capture an image and transmit the image by remaining at a site for each autonomous driving stop condition. For example, when the suspicious vehicle described above is detected, the automatic driving vehicle 100 terminates the operation mode (second autonomous driving mode) of continuing to capture an image and transmit the image by remaining at the site when capturing an image of the target vehicle is completed. Similarly, when a traffic accident vehicle is detected, the automatic driving vehicle 100 terminates the operation mode (second autonomous driving mode) of continuing to capture an image and transmit the image by remaining at the site when arrival of an emergency vehicle such as a police or an ambulance has been checked. Similarly, when a suspicious person is detected, the automatic driving vehicle 100 terminates the operation mode (second autonomous driving mode) of continuing to capture an image and transmit the image by remaining at the site when a predetermined time elapses. As described above, setting the termination condition for each autonomous driving stop condition enables prompt return to an operation mode of moving autonomously based on the information set in advance.

The determination means 104 has a function of checking whether an event has occurred as described above, the function being available using a method put to practical use in an abnormality detection system or the like that detects an abnormality in a place appearing in a camera using artificial intelligence (AI). For example, the “suspicious vehicle”, the “traffic accident”, and the “suspicious person” can be detected from their external characteristics and movement.

When determining that an event conforming to the autonomous driving stop condition has occurred, the determination means 104 notifies the control means 105 of contents of the event having occurred.

When receiving the notification that the event conforming to the autonomous driving stop condition has occurred, the control means 105 shifts to the operation mode (second autonomous driving mode) of continuing to capture an image and transmit the image to the control center 200 by remaining at the site in accordance with the event having occurred. When the termination condition defined for each autonomous driving stop condition are satisfied, the control means 105 terminates the operation mode (second autonomous driving mode) of continuing to capture an image and transmit the image by remaining at the site and returns to the operation mode of moving autonomously based on the information set in advance. Conceivable examples of a method for the automatic driving vehicle 100 to remain at the site include a method of moving to a road shoulder of a road and stopping, and a method of riding on a sidewalk and stopping.

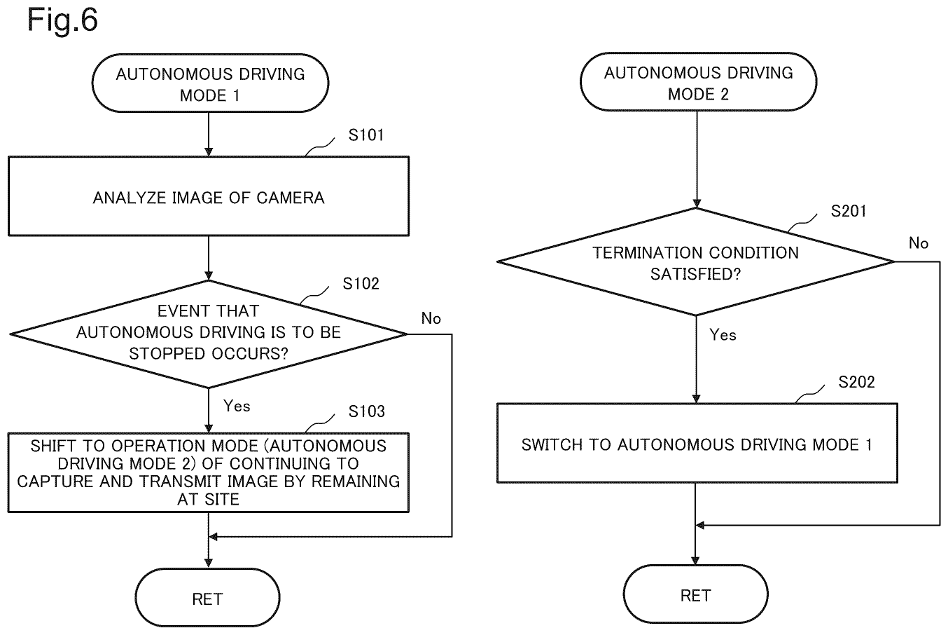

Subsequently, operation of the present example embodiment will be described in detail with reference to the drawings. FIG. 6 is a flowchart illustrating an operation of the automatic driving vehicle 100 according to the first example embodiment of the present disclosure. FIG. 6 includes a flowchart on the left side, the flowchart illustrating an operation of the automatic driving vehicle 100 operating in its initial autonomous driving mode (first autonomous driving mode). First, the automatic driving vehicle 100 analyzes images of the camera 101 at predetermined time intervals (step S101).

When it is determined that an event conforming to the autonomous driving stop condition illustrated in FIG. 5 has occurred (Yes in step S102) as a result of the analysis, the automatic driving vehicle 100 stops the initial autonomous driving, and shifts to the operation mode (second autonomous driving mode) of continuing to capture an image and transmit the image to the control center 200 by remaining at the site (step S103). In contrast, when no event conforming to the autonomous driving stop condition has occurred, the automatic driving vehicle 100 continues the operation in the autonomous driving mode (No in step S102).

FIG. 6 includes a flowchart on the right side, the flowchart illustrating an operation of the automatic driving vehicle 100 operating in the second autonomous driving mode. When the termination condition of the second autonomous driving mode such as completion of collection of predetermined information are satisfied during the operation in the second autonomous driving mode (Yes in step S201), the automatic driving vehicle 100 returns the driving mode to the initial autonomous driving mode (first autonomous driving mode) (step S202). Then, the automatic driving vehicle 100 restarts an operation before the occurrence of the event conforming to the autonomous driving stop condition. Meanwhile, until the termination condition of the second autonomous driving mode is satisfied, the automatic driving vehicle 100 continues the operation in the second autonomous driving mode (No in step S201).

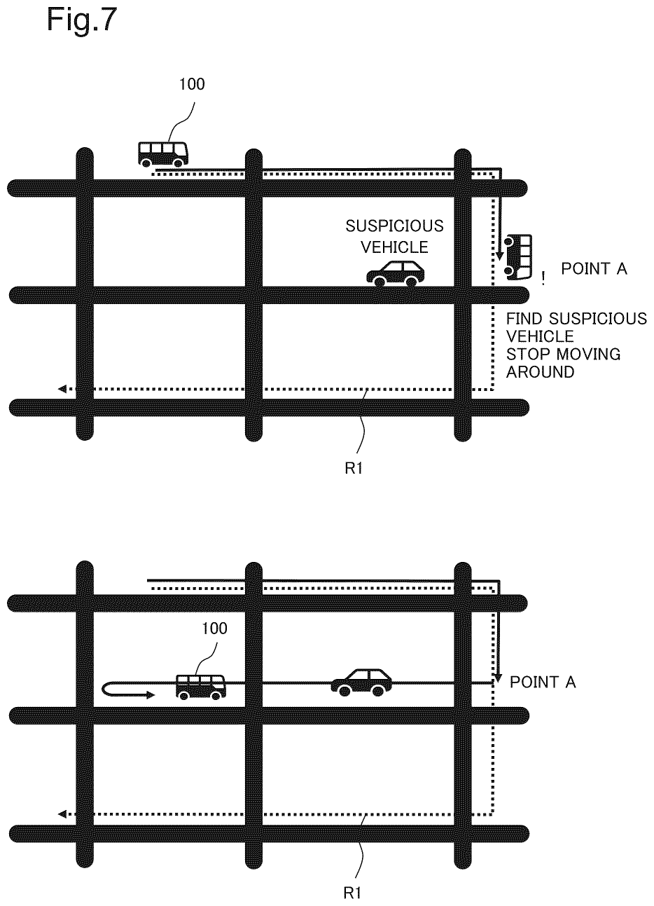

FIG. 7 is a diagram for illustrating the operation of the automatic driving vehicle according to the first example embodiment of the present disclosure. FIG. 7 shows a reference sign RI that indicates a round route of the automatic driving vehicle 100 in the first autonomous driving mode. As illustrated in an upper part of FIG. 7, it is assumed that the automatic driving vehicle 100 travels along the round route R1 and arrives at a point A to find a suspicious vehicle. In this case, the automatic driving vehicle 100 determines that an event conforming to the autonomous driving stop condition has occurred, and shifts to the operation mode (second autonomous driving mode) of continuing to capture an image and transmit the image to the control center 200 by remaining at the site. Then, the automatic driving vehicle 100 turns to the front of the suspicious vehicle as illustrated in a lower part of FIG. 7 and captures images of the vehicle and the number plate and transmits the images. The person in charge of the control center 200 determines not only whether to address the suspicious vehicle but also contents of the addressing with reference to the images transmitted from the automatic driving vehicle 100. Meanwhile, the automatic driving vehicle 100 returns to the first autonomous driving mode after collecting necessary information, and restarts traveling along the round route R1.

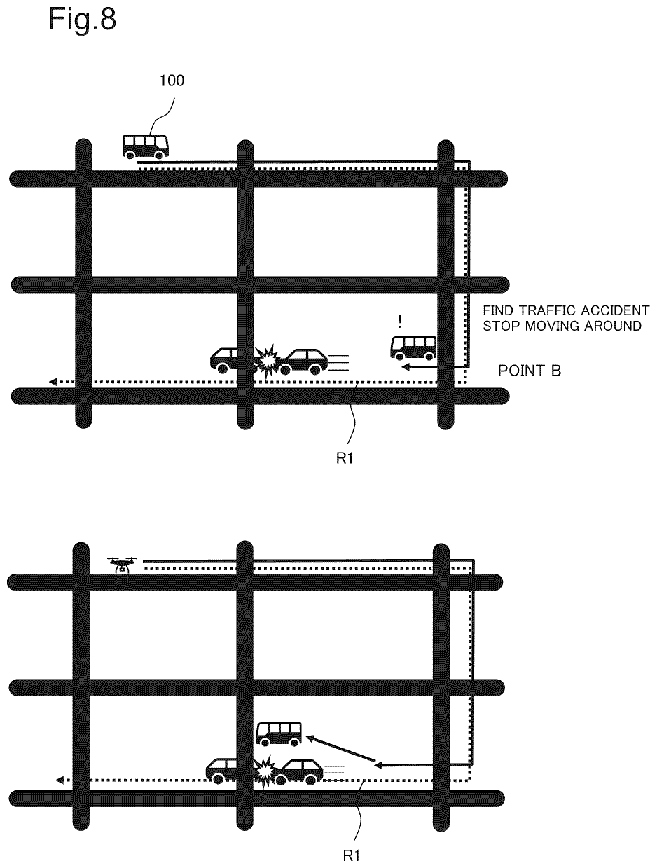

FIG. 8 is another diagram for illustrating the operation of the automatic driving vehicle according to the first example embodiment of the present disclosure. FIG. 8 also shows a reference sign RI that indicates a round route of the automatic driving vehicle 100 in an autonomous driving mode. As illustrated in an upper part of FIG. 8, it is assumed that the automatic driving vehicle 100 travels along the round route R1 and arrives at a point B to encounter a traffic accident due to collision of vehicles. Even in this case, the automatic driving vehicle 100 determines that an event conforming to the autonomous driving stop condition has occurred, and shifts to the operation mode (second autonomous driving mode) of continuing to capture an image and transmit the image to the control center 200 by remaining at the site. Then, the automatic driving vehicle 100 stops near the traffic accident site as illustrated in a lower part of FIG. 8, and captures images of a situation of the site including a situation of relief of an injured person and transmits the images. The person in charge of the control center 200 determines not only whether to address the traffic accident but also contents of the addressing with reference to the images transmitted from the automatic driving vehicle 100. These images are also available at a later date not only for calculation of a percentage of negligence in the traffic accident, but also as a record indicating whether contents of the relief of the injured person provided by a person in charge was appropriate. Meanwhile, the automatic driving vehicle 100 returns to the first autonomous driving mode after an emergency vehicle arrives, and restarts traveling along the round route R1.

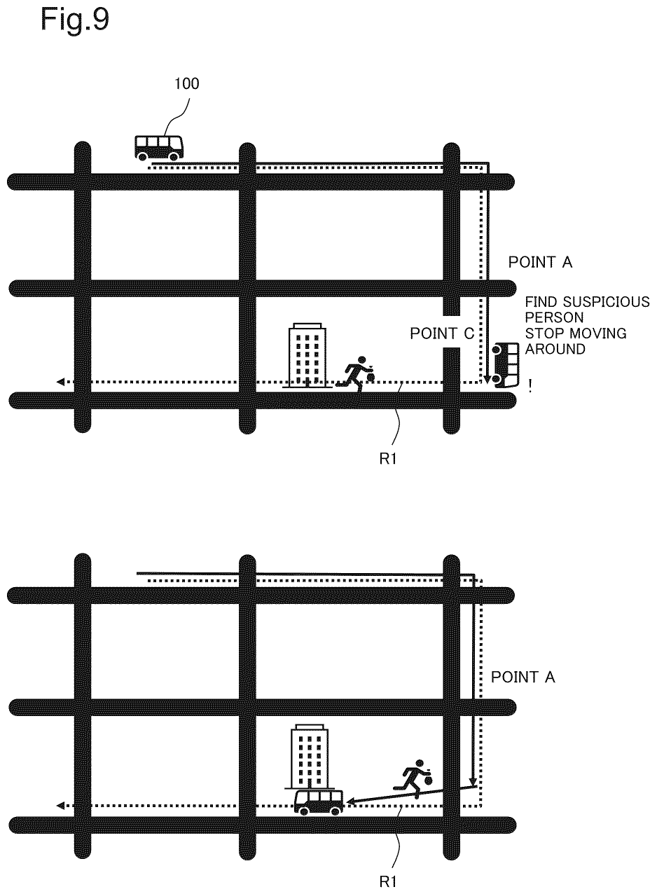

FIG. 9 is yet another diagram for illustrating the operation of the automatic driving vehicle according to the first example embodiment of the present disclosure. FIG. 9 also shows a reference sign RI that indicates a round route of the automatic driving vehicle 100 in an autonomous driving mode. As illustrated in an upper part of FIG. 9, it is assumed that the automatic driving vehicle 100 travels along the round route R1 and arrives at a point C to find a suspicious person. Even in this case, the automatic driving vehicle 100 determines that an event conforming to the autonomous driving stop condition has occurred, and shifts to the operation mode (second autonomous driving mode) of continuing to capture an image and transmit the image to the control center 200 by remaining at the site. Then, the automatic driving vehicle 100 stops near a place where the suspicious person is found as illustrated in a lower part of FIG. 9, and continues to capture images and transmit the images. The person in charge of the control center 200 determines not only whether to address the suspicious person but also contents of the addressing with reference to the images transmitted from the automatic driving vehicle 100. These images are also available at a later date as evidence in an investigation by the police or trial. Meanwhile, the automatic driving vehicle 100 returns to the first autonomous driving mode after a predetermined time elapses, and restarts traveling along the round route R1.

As described above, the present example embodiment enables the automatic driving vehicle 100 traveling autonomously to be used as a means for grasping contents of an event by staying the vehicle at a place where the event has occurred near a route of the vehicle. Additionally, the number of times of dispatching personnel as in the method described in the background art can be suppressed, so that operation cost can also be dramatically reduced.

### Second Example Embodiment

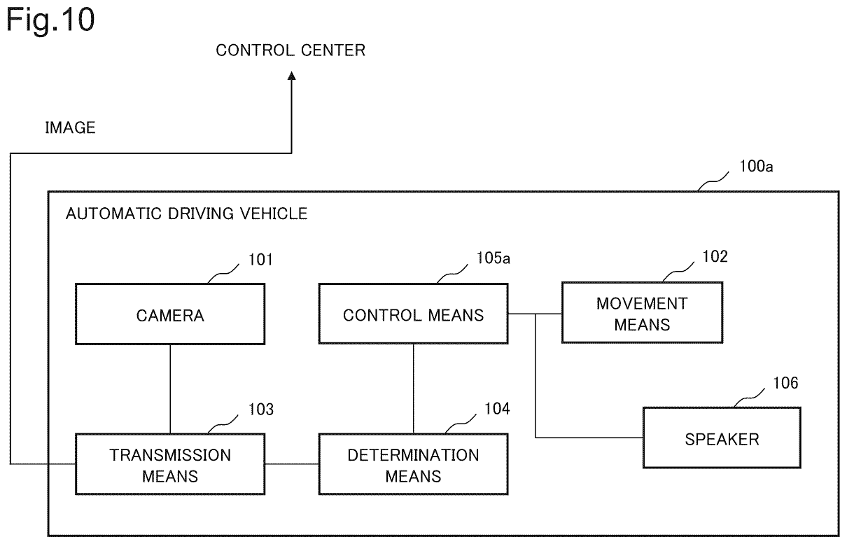

Subsequently, a second example embodiment will be described in detail, in which a sound output function is added to an automatic driving vehicle 100a, with reference to the drawings. FIG. 10 is a block diagram illustrating a configuration of the automatic driving vehicle 100a according to the second example embodiment of the present disclosure. The second example embodiment is different from the first example embodiment illustrated in FIG. 4 in that a speaker 106 is added to the automatic driving vehicle 100a. Other configurations are similar to those of the first example embodiment, and thus will not be described to mainly describe differences.

The speaker 106 is configured to be able to output a voice or a warning sound registered in advance.

The present example embodiment enables calling attention to surrounding passersby or the like by outputting a voice or a warning sound in the situations illustrated in FIGS. 7 to 9, for example.

### Third Example Embodiment

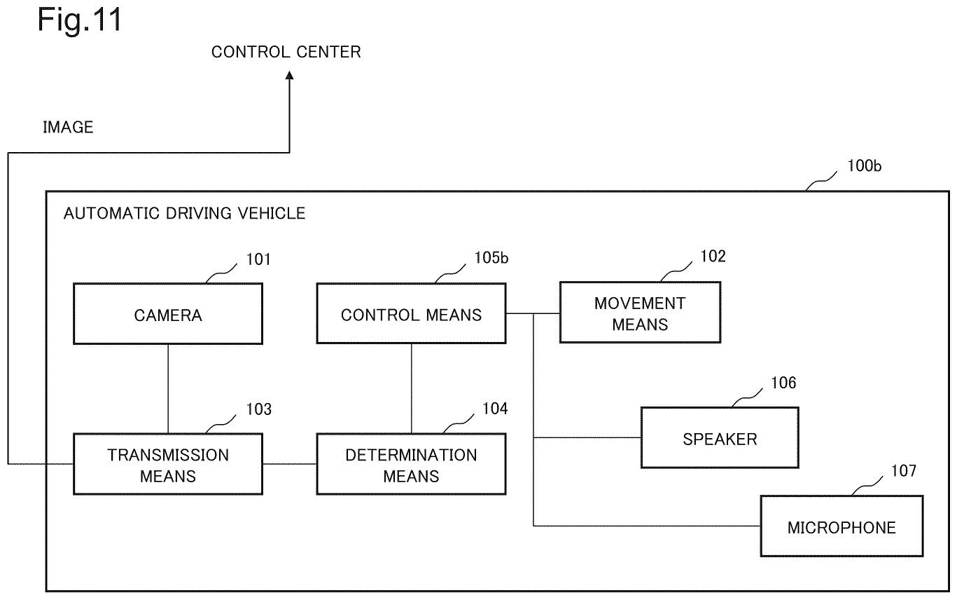

As illustrated in FIG. 11, an automatic driving vehicle 100b in another form may be equipped with a microphone 107 to be able to transmit a voice from the automatic driving vehicle 100b to the control center 200. This configuration enables the person in charge of the control center 200 to talk with a person in the site and record a voice of the site.

### Fourth Example Embodiment

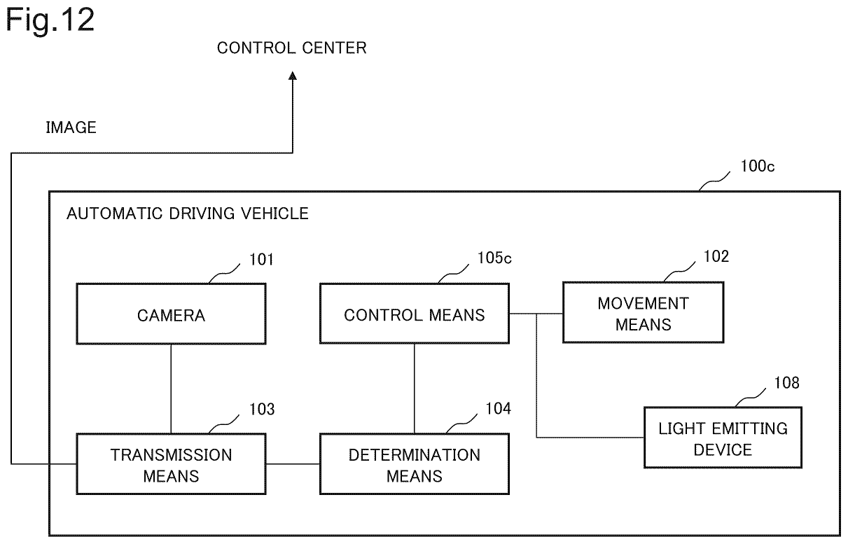

As illustrated in FIG. 12, an automatic driving vehicle 100c in yet another form may be equipped with a light emitting device 108. As the light emitting device 108, a device such as a light emitting diode (LED) capable of emitting light with high luminance, a rotating lamp, or the like can be suitably used. This configuration enables the automatic driving vehicle 100c to call attention to surrounding persons by turning on the light emitting device 108 in the second autonomous driving mode. Turning on the light emitting device 108 in the situations illustrated in FIGS. 7 to 9, for example, enables a passenger of the vehicle to recognize that a parked vehicle is detected and an image of the parked vehicle is captured.

In the second to fourth example embodiments described above, it is also preferable to define different operation contents and termination conditions for the speaker 106 or the light emitting device 108 for each autonomous driving stop condition. This configuration enables warning operation associated with the autonomous driving stop condition to be performed, examples of the warning operation including: approaching with a warning sound sounding from the speaker 106 when a suspicious vehicle is found; and capturing an image silently without outputting a voice when a traffic accident or a suspicious person is found. Similarly, this configuration also enables the light emitting device 108 to perform warning operation associated with the autonomous driving stop condition, examples of the warning operation including: emitting light when a suspicious vehicle or a traffic accident is found; and capturing an image silently without emitting light when a suspicious person is found.

### Hardware Configuration

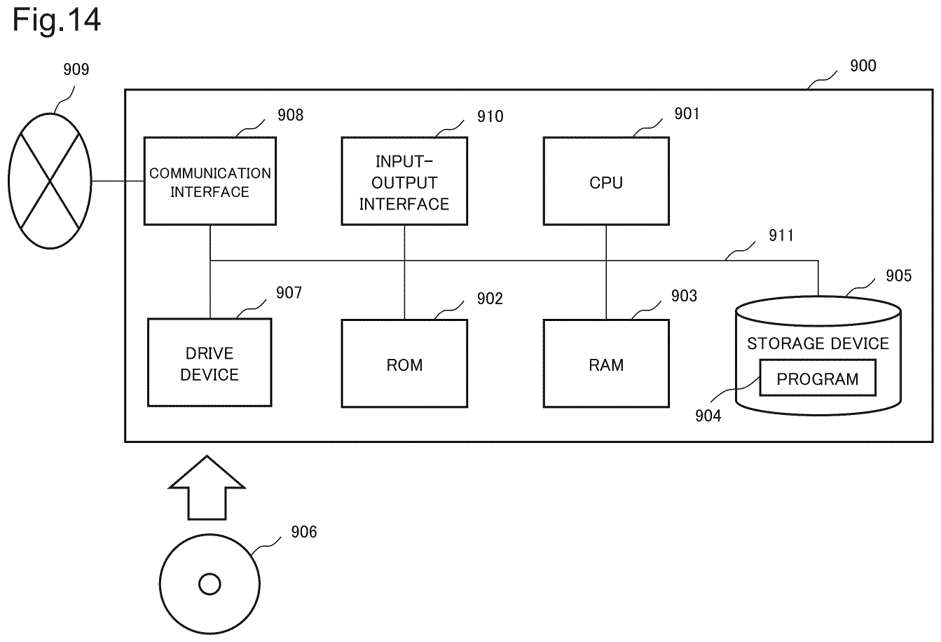

In each example embodiment of the present disclosure, each component of each device indicates a block of a functional unit. Some or all of components of each device are implemented by any combination of an information processing device 900 and a program as illustrated in FIG. 14, for example. FIG. 14 is a block diagram illustrating an example of a hardware configuration of the information processing device 900 that achieves each component of each device. The information processing device 900 includes the following configuration as an example.
A central processing unit (CPU) 901
A read only memory (ROM) 902
A random access memory (RAM) 903
A program 904 loaded into the RAM 903
A storage device 905 storing the program 904
A drive device 907 that reads and writes a recording medium 906
A communication interface 908 connected to a communication network 909
An input-output interface 910 for inputting and outputting data
A bus 911 connecting each component

Each component of each device in each example embodiment is implemented by the CPU 901 acquiring and executing the program 904 for implementing a function of the component. That is, the CPU 901 of FIG. 14 may execute a program for determining whether an event for which the autonomous driving is to be stopped has occurred or a program for switching to a driving mode to execute update processing of each of calculation parameters held in the RAM 903, the storage device 905, and the like. The program 904 for implementing the function of each component of each device is stored in the storage device 905 or the ROM 902 in advance, for example, and is read by the CPU 901 as necessary.

The program 904 may be supplied to the CPU 901 through the communication network 909, or may be stored in advance in the recording medium 906, and the drive device 907 may read the program and supply the program to the CPU 901.

The program 904 enables a display device to display a processing result including an intermediate state for each stage as necessary, or enables the communication interface to communicate with the outside.

The program 904 can be recorded on a computer-readable (non-transitory) storage medium.

Each device is implemented by a method among various modifications. For example, each device may be implemented by any independent combination of the information processing device 900 and a program for each component. Each device includes a plurality of components that may be implemented by any combination of one information processing device 900 and a program. That is, each device can be implemented by a computer program that causes a processor mounted in the device described in corresponding one of the first to fifth example embodiments to execute each processing described above using hardware of the device.

Some or all of components of each device are implemented by another general-purpose or dedicated circuit, another processor and the like, or a combination thereof. These components may be composed of a single chip, or may be composed of a plurality of chips connected to each other with a bus.

Some or all of the components of each device may be implemented by a combination of the circuit and the like described above, and a program.

When some or all of the components of each device are implemented by a plurality of information processing devices, circuits, and the like, the plurality of information processing devices, circuits, and the like may be disposed in a centralized manner or in a distributed manner. For example, the information processing devices, the circuits, and the like may be implemented as a form in which each of them is connected through a communication network, such as a client and server system or a cloud computing system.

Each of the example embodiments described above is a preferred example embodiment of the present disclosure, and the scope of the present disclosure is not limited only to each of the example embodiments described above. That is, those skilled in the art can modify or substitute the example embodiments described above without departing from the gist of the present disclosure to construct a form with a variety of changes conducted.

The first to fourth example embodiments described above have respective features that can be combined to form another example embodiment. For example, the automatic driving vehicles of the second, third, and fourth example embodiments can be combined to form an automatic driving vehicle having a voice output function, a call function, and a light emission function.

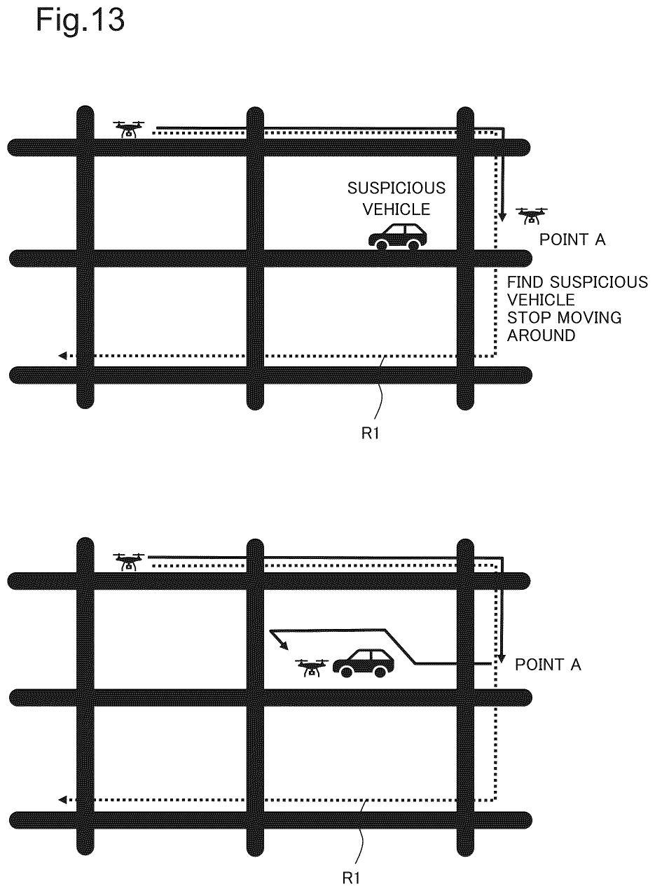

Although the first to fourth example embodiments described above each describe an example in which the automatic driving vehicle is used as the moving body, a drone or a robot having an autonomous driving function can also be used as the moving body. For example, when the determination means and the control means of the present disclosure are added to a drone or the like that transmits an image while moving around along a predetermined round course, the moving body of the present disclosure can be configured. For example, it is assumed that the drone arrives at the point A to find a parked vehicle as illustrated in FIG. 13. In this case, the drone determines that an event conforming to the autonomous driving stop condition has occurred, and continues to capture an image and transmit the image to the control center by remaining at a site (fifth example embodiment).

Some or all of the example embodiments described above may be described as in Supplementary Notes below, but are not limited to the Supplementary Notes.

### Supplementary Note

A moving body including:
a camera;
a movement means for autonomous moving based on information set in advance;
a transmission means for transmitting an image captured by the camera to a predetermined control center during movement using the movement means;
a determination means for determining whether an event appearing in the image captured by the camera conforms to a predetermined autonomous driving stop condition; and
a control means for shifting to an operation mode when an event conforming to the autonomous driving stop condition has occurred, the operation mode being for remaining at a location where the event has occurred and continuing to capture an image and transmit the image to the predetermined control center.

### Supplementary Note 2

The control means of the moving body described above can be configured to cause movement to a position determined for each of autonomous driving stop conditions and continue to transmit an image to the control center.

### Supplementary Note 3

One of positions defined for the respective autonomous driving stop conditions described above is defined as a position for capturing an image of a target vehicle from ahead at a predetermined distance.

### Supplementary Note 4

The control means of the moving body described above can be configured to terminate the operation mode based on a termination condition defined for each of the autonomous driving stop conditions.

### Supplementary Note 5

The moving body described above further includes a speaker or a light emitting device, in which the control means can be configured to enable the speaker or the light emitting device to perform a warning operation by determining operation contents for each of the autonomous driving stop conditions.

### Supplementary Note 6

A method for controlling a moving body, the method including:
allowing a moving body including a camera; a movement means for autonomous moving based on information set in advance; and a transmission means for transmitting an image captured by the camera to a predetermined control center during movement using the movement means to determine whether an event appearing in the image captured by the camera conforms to a predetermined autonomous driving stop condition;
remaining at a location where the event has occurred when the event conforming to the autonomous driving stop condition has occurred; and
continuing to capture an image and transmitting the image to the predetermined control center.

### Supplementary Note 7

A recording medium recording a program for causing a computer to execute processing, the computer being mounted on a moving body including: a camera; a movement means for autonomous moving based on information set in advance; and a transmission means for transmitting an image captured by the camera to a predetermined control center during movement using the movement means, the processing including:
determining whether an event appearing in the image captured by the camera conforms to a predetermined autonomous driving stop condition; and
remaining at a location where the event has occurred and continuing to capture an image and transmit the image to the predetermined control center when the event conforming to the autonomous driving stop condition has occurred.

The forms of the Supplementary Notes 6 and 7 can be expanded to the forms of the Supplementary Notes 2 to 5, as in the Supplementary Note 1.

The disclosure of the above PTL is incorporated herein by reference, and can be used as a basis or part of the present disclosure as necessary. Within the scope of the entire disclosure (including the scope of claims) of the present invention, the example embodiments or examples can be changed and adjusted based on the basic technical idea of the entire disclosure. Within the scope of the entire disclosure, various combinations or selections (including partial deletions) of various disclosure elements (each element of each claim, each element of each example embodiment or example, each element of each drawing, and the like are included) also can be made. That is, it is a matter of course that the present disclosure includes various modifications and corrections that can be made by those skilled in the art in accordance with the entire disclosure including the scope of claims and the technical idea.

Specifically, the numerical ranges described herein should be interpreted to include any numerical value or sub-range included within the ranges unless otherwise described. Additionally, the matters disclosed in the literature cited above are deemed to be included in the matters disclosed in the present application as a part of the disclosure herein by being partially or entirely combined with the matters described in the present specification according to the gist of the present disclosure as necessary.

### REFERENCE SIGNS LIST

10 moving body
11,101 camera
12, 102 movement means
13, 103 transmission means
14, 104 determination means
15, 105 control means
100, 100a to 100c automatic driving vehicle
106 speaker
107 microphone
108 light emitting device
900 information processing device
901 central processing unit (CPU)
902 read only memory (ROM)
903 random access memory (RAM)
904 program
905 storage device
906 recording medium
907 drive device
908 communication interface
909 communication network
910 input-output interface
911 bus
R1 round route

What is claimed is:

1. A moving body comprising:
a camera;
one or more memories storing instructions; and
one or more processors configured to execute the instructions to:
control the moving body to move autonomously based on information set in advance;
transmit an image captured by the camera to a predetermined control center while moving autonomously;
determine whether an event appearing in the image captured by the camera conforms to a predetermined autonomous driving stop condition; and
shift to an operation mode when an event conforming to the autonomous driving stop condition has occurred, the operation mode being for remaining at a location where the event has occurred and continuing to capture an image and transmit the image to the control center.

2. The moving body according to claim 1, wherein the one or more processors are further configured to execute the instructions to:
move to a position determined for each of autonomous driving stop conditions; and
continue to transmit an image to the control center.

3. The moving body according to claim 2, wherein one of positions defined for the respective autonomous driving stop conditions is defined as a position for capturing an image of a target vehicle from ahead at a predetermined distance.

4. The moving body according to claim 1, wherein the one or more processors are further configured to execute the instructions to terminate the operation mode based on a termination condition defined for each of the autonomous driving stop conditions.

5. The moving body according to claim 1, further comprising:
a speaker or a light emitting device, wherein the one or more processors are further configured to execute the instructions to cause the speaker or the light emitting device to perform a warning operation by determining operation contents for each of the autonomous driving stop conditions.

6. A method for controlling a moving body, the method comprising:
determining, by a moving body including a camera; one or more memories storing instructions; and one or more processors configured to execute the instructions to: control the moving body to move autonomously based on information set in advance; and transmit an image captured by the camera to a predetermined control center while moving autonomously to determine whether an event appearing in the image captured by the camera conforms to a predetermined autonomous driving stop condition;
remaining at a location where the event has occurred when the event conforming to the autonomous driving stop condition has occurred; and
continuing to capture an image and transmitting the image to the control center.

7. A non-transitory recording medium recording a program for causing a computer to execute processing, the computer being mounted on a moving body including: a camera; one or more memories storing instructions; and one or more processors configured to execute the instructions to: control the moving body to move autonomously based on information set in advance; and transmit an image captured by the camera to a predetermined control center while moving autonomously, the processing comprising:
determining whether an event appearing in the image captured by the camera conforms to a predetermined autonomous driving stop condition; and
remaining at a location where the event has occurred and continuing to capture an image and transmit the image to the control center when the event conforming to the autonomous driving stop condition has occurred.
